(19) United States
(12) Patent Application Publication
(10) Pub. No.: US 2005/0200037 A1
(43) Pub. Date: Sep. 15, 2005

(54) Pipeline pig

(76) Inventor: Simon Sanders, Salisbury (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/517,806

(22) PCT Filed: Jun. 11, 2003
(86) PCT No.: PCT/GB03/02513

§ 371 Date: Apr. 20, 2005

(30) Foreign Application Priority Data
Jun. 11, 2002 (GB) 02133882
Jul. 24, 2002 (GB) 02171429

(51) Int. Cl. F16L 55/16

(52) U.S. Cl. 264/36.17; 138/98; 138/97; 264/516; 264/35; 427/238; 156/294

(57) ABSTRACT

A pipeline pig (1), and method for installing a liner into a pipework, the pipeline pig comprises longitudinal inner (7) and outer (6) walls, and end walls (10, 12), said inner and outer walls being of substantially annular arrangement in transverse section, the pipeline pig being such that, in use, space enclosed by said walls is filled with fluid, and when a pressurising fluid is applied to the rearward end of the pipeline pig the pig advances through the pipeline by way of substantially radial portions of the walls moving in respective endless loops. The pipeline pig exerts a radially outward pressure to a liner (16) so as to urge said liner against an inner surface (40) of the pipework. The inventive pipeline pig can also be used to clear unwanted material from a pipework.

The present invention relates to pipeline pigs, and in particular, but not exclusively, to pipeline pigs for installing a lining in a pipeline. The present invention also relates to methods of lining pipelines and clearing pipelines.

A commonly used method for repairing pipes is to insert a flexible tubular liner such as, in the case of the repair of underground drain pipes, a tube of fibrous material such as felt, impregnated with a fluid material such as a resin which, after an interval or as the result of the application of a process such as heating, sets hard. Known apparatus and methods for installing such liners are often cumbersome. The present invention seeks to provide an alternative method for installing a pipeline liner.

According to a first aspect of the invention there is provided pipeline lining apparatus comprising a pipeline pig and an inner tube, the pipeline pig comprising longitudinal inner and outer walls and end walls, said inner and outer walls being of substantially annular arrangement in transverse section, the pig being such that, in use, space enclosed by said walls is filled with fluid, and on applying a motive force to the pipeline pig, the pipeline pig advances along a pipeline by way of substantially radial portions of the walls following respective endless loops, the apparatus being such that, in use, the pipeline liner and the inner tube are located within a pipeline, the inner tube being spread out against an inner surface of the pipeline liner prior to insertion into the pipeline, and the pipeline pig is caused to pass through the pipeline liner and the inner tube so as to urge said pipeline liner and said inner tube radially outwards towards an inner surface of the pipeline.

The term ‘pipeline pig’ should be understood to include a moveable occlusion device which is capable of being advanced through a pipeline, for example a drain.

In a preferred embodiment of the invention there is provided a pipeline pig that may be used to provide a substantially fluid-tight seal within a tubular channel such as a pipe and to apply pressure to an inner surface of the pipe to install a flexible liner within the pipe using the pipeline pig.

In one embodiment, the invention provides a method for forming a liner against the inner surface of the pipe under repair and for retaining the liner in position whilst subsequent processes, such as a hardening process, proceed.

The pipeline pig preferably comprises a closed central passage.

The pipeline pig preferably comprises a flexible tubular membrane everted at each distal end with the two distal ends brought together and joined around the circumference thereof to form a fully enclosed container. Preferably the enclosed void is filled with gas or liquid under pressure or a combination of gas and liquid under pressure. The ratio of the length of the pipeline pig to the circumference of the pipeline pig is such that the outer surface of the pipeline pig is substantially that of cylinder in shape over the main part of the length of the pig. The ratio of the length of the pig is preferably at least one and a half times the external diameter of the pig. The pressure of the gas or liquid or combination of gas and liquid in the pipeline pig is sufficient to urge radially inwardly or compress that portion of the tubular membrane that passes longitudinally through the middle of the pipeline pig which defines a central passage and to close said central passage.

According to a second aspect of the invention there is provided a method of installing a pipeline liner in a pipeline comprising positioning the pipeline liner in the pipeline, positioning a pipeline pig towards one end of the pipeline liner and applying a motive force to the pipeline pig so as to cause the pipeline pig to advance through the pipeline liner, the pipeline pig comprising longitudinal inner and outer walls, and end walls, said inner and outer walls being of substantially annular arrangement in transverse section, the pipeline pig being such that, in use, space enclosed by said walls is filled with fluid, and the pipeline pig advances along the pipeline by way of substantially radial portions of the walls moving in respective endless loops, the method further comprising positioning a pipeline liner and an inner tube in the pipeline, the inner tube being spread out against an inner surface of the pipeline liner prior to insertion into the pipeline, and causing the pipeline pig to pass through the pipeline liner and the inner tube so as to urge said pipeline liner and said inner tube radially outwards towards an inner surface of the pipeline.

The method preferably comprises applying a pressurising fluid (which may be a gas, a liquid or a combination of both) to a rearward end of the pipeline pig.

The method preferably comprises arranging that an outer surface of the pig exerts a radially outward force towards an inner surface of the pipeline.

The method preferably comprises arranging that the external diameter of the pipeline pig is at least that of the internal diameter of the pipeline, and preferably the external diameter of the pig is greater than that of the internal diameter of the pipeline. It will be appreciated however that the external diameter of the pipeline pig may be greater than the internal diameter of the liner or of inner protective tube but less than the internal diameter of the pipe.

The pipeline pig is preferably radially compressible. If the flexible tubular membrane forming the skin of the pipeline pig comprises an elastic material, radial compressibility is afforded by the elasticity of the tubular membrane and by the compressibility of gas contained therein (if present). If, however, the flexible tubular membrane consists of a substantially inelastic material, the pipeline pig may be filled with gas or a combination of gas and liquid and radial compressibility is afforded by The compressibility of the gas.

The pipeline pig is desirably adapted to be inserted into a pipe or tubular conduit (for example a drain) where the cross-sectional area of the pipeline pig is greater than the cross-sectional area of the pipe in which it is inserted. In either case it is highly preferred that the dimensions of an individual pipeline pig depend on those of the pipe in which it is intended to be used and are such that, when the pipeline pig is inserted into a pipe, the pipeline pig presses against the inner tube and accordingly against the inner surface of a pipeline liner the pipe around the complete circumference thereof and provides a complete seal within the inner tube.

Thus, in order to effect the obstruction or sealing of a pipe and to apply pressure to the inner surface of the said pipe, the invention desirably provides a pipeline pig with dimensions such that, when the pipeline pig is inserted into the pipe, the radially outer surface of the pig bears radially outwardly against the inner surface of the inner tube around the complete circumference of the inner tube and provides a complete seal within the inner tube. This may be achieved by using a pipeline pig with, when uncompressed, a cross-sectional area that is greater than the cross-sectional area of the said pipe. The seal effected between the radially outer surface of the pig and the inner surface of the inner tube preferably substantially prevents gas or liquid from passing from one distal end of the pig to the opposite end of the pig.

Preferably, in use, the longitudinal radially inner portions of the pig move in the direction of displacement of the pig, and the position in the respective endless loop of material forming the longitudinal radially outer portions of the pig moves in a direction opposite to the direction of displacement of the pig.

By applying a suitable motive force, the pipeline pig may be caused to move along the pipeline by what may be termed a longitudinal rolling motion whereby the radially inner skin of the tubular membrane that passes through the middle of the pipeline pig moves forwards and emerges at the forward end and spreads to form the radially outer skin of the pipeline pig. At the same time, the outer skin at the rearward end of the pipeline pig gathers towards the longitudinal axis and is drawn into the middle of the pipeline pig.

In one embodiment of the invention, the pipeline pig is constructed so that any resistance to longitudinal rolling motion inherent in the pipeline pig is minimised. Methods for achieving this include but are not limited to using an elastic tubular membrane of a material with a high degree of flexibility and a smooth, non-sticky low resistance surface. In another embodiment of the invention, the pipeline pig is constructed so that inherent resistance to longitudinal rolling motion is enhanced (ie increased). Methods for achieving this include but are not limited to using a tubular membrane of a substantially inelastic material, using a tubular membrane with a sticky or high resistance surface and filling the pipeline pig with a gas at a higher pressure than may otherwise be used (so that a greater force is required to advance the pig against such increased pressure).

In one embodiment of the invention, a rod or line is provided which passes longitudinally through the central passage of the pipeline pig, the outer surface of the rod or line providing frictional contact with the pipeline pig. Such a line or rod may provide means for propelling the pipeline pig through the pipe by pulling on or pushing on the rod or line. The pipeline pig is most preferably subject to an external propulsive force such as fluid pressure at one end, and the rod or line may be used for restraining the pipeline pig in the pipe by restraining or pushing or pulling the rod or line, using a force sufficient to overcome the external propulsive force.

In one embodiment, the invention provides a means for propelling a pipeline pig through a pipe by introducing a pressurising medium comprising gas or liquid under pressure or a combination of gas and liquid under pressure into the pipe at one end of the pipeline pig. The pressure applied to the pig by the pressurising medium is sufficient to overcome any inherent resistance to longitudinal rolling motion in the pipeline pig, causing the pipeline pig to be propelled in the direction away from the end that is in contact with the pressurising medium. There may be provided means for slowing, stopping or reversing the advancing motion of the pipeline pig thus caused by introducing a second pressurising medium at the opposite end of the pipeline pig which is sufficient to cause the motion of the pipeline pig to be slowed, stopped or reversed.

Preferably there is provided an end-cap for attachment to either end of the pipe in which the pipeline pig is deployed where it is desired to retain the pressurising medium. The end-cap is formed so that it is gas-tight and/or liquid-tight and may be attached to the pipe by a gas-tight and/or liquid-tight joint and may be constructed so that the joint can be opened readily for ease of access to the interior of the pipe. The end-cap may contain one or more apertures through which a pressurising medium such as a gas or a liquid or a combination of gas and liquid may be introduced into the pipe. The end-cap may contain one or more devices for regulating the pressure of a pressurising medium such as a gas or a liquid or a combination of gas and liquid within the pipe, such as a pressure relief valve. The end-cap may contain one or more apertures such as a gland through which rods, lines, cables or tubes or devices such as, but not limited to, sources of heat, light and other forms of radiation, cameras, detection, measuring devices, cutters and manipulators may be inserted into and withdrawn from the interior of the pipe without significant leakage of or loss of pressure in any pressurising medium such as a gas or a liquid or a combination of gas and liquid within the pipe. The end-cap may contain provision for retaining one or more devices such as, but not limited to, sources of heat, light and other forms of radiation, cameras, detection, measuring devices, cutters and manipulators and for deploying such apparatus within the pipe without significant leakage of or loss of pressure in any pressurising medium such as a gas or a liquid or a combination of gas and liquid within the pipe. The end-cap may be integral with the liner or with the protective inner tube and/or may be made of flexible material.

In order to facilitate the introduction of a pipeline pig into a pipe and to introduce the pressurising medium into the void between the near end of the pipeline pig and the near end of the pipe, the invention preferably provides an end-chamber (or launch chamber) which is longitudinally larger than the end cap, of which the internal surface is preferably substantially cylindrical in shape, closed at one distal end and open at the other distal end. The end-chamber is preferably substantially similar in cross-sectional area to the pipe into which the pipeline pig is to be introduced and is of a length sufficient to accommodate the pipeline pig. The open end of the end-chamber is formed so that it may be connected to the end of the pipe by a gas-tight and/or liquid-tight joint. A pressurising aperture is provided at the closed end of the end-chamber through which the pressurising medium may be introduced under pressure into the end-chamber. A method is provided whereby the pipeline pig is positioned within the end-chamber, the open end of the end-chamber is connected to the end of the pipe by a gas-tight and/or liquid-tight joint, and the pressurising medium is introduced through the pressurising aperture into a void between the near end of the pipeline pig and the closed end of the end-chamber, propelling the pipeline pig out of the end chamber and into and through the pipe.

The end-chamber may contain additional features as follows:
1. One or more access apertures such as a gland through which a rod, cable, tube, line or other devices, including but not limited to cameras, heating devices, light sources, ultra-violet radiation sources, cutting devices and manipulation devices for deploying within the pipe, including devices connected to rods, cables, tubes or lines, may be introduced into the end-chamber from outside the end-chamber and may be removed from within the end-chamber.
2. One or more devices for measuring and controlling the pressure of the pressurising medium.
3. Means for accommodating and deploying devices including but not limited to cameras, heating devices, light sources, ultra-violet radiation sources, cutting devices and manipulation devices for deploying within the pipe, including devices connected to rods, cables, tubes or lines passing through said access apertures.
4. One or more pressurising apertures at the open end of the end-chamber through which gas or liquid or a combination of gas and liquid may be introduced into the void at the remote end of the pipeline pig.

In order to introduce a pressurising medium into the void in the pipe at the remote end of the pipeline pig, the following alternative methods may be provided:
1. Means for introducing the pressurising medium through an aperture at the remote end of the pipe.
2. A pass-through tube which passes through the passage which passes longitudinally through the central passage of the pipeline pig, through which the tube pressurising medium may be passed. The pass-through tube may be used to restrain the pipeline pig in a fixed position or may be lubricated so that it may be withdrawn. If the pass-through tube is to be withdrawn, it may be necessary to use alternate means for holding the pipeline pig in a fixed position as the pressure of the pressurising medium increases.
3. A bypass tube which passes longitudinally between the inner surface of the pipe and the pipeline pig. The bypass tube is constructed of a thin tubular membrane or, if a harder material is used, shaped so as to minimise or eliminate any leakage of gas or liquid between the void in the pipe at one end of the pipeline pig and the void in the pipe at the other end of the pipeline pig
4. An end-chamber wherein there is a pressurising aperture located near to the open end, through which the pressurising medium may be passed into the void at the remote end of a pipeline pig positioned within the said end-chamber. A second pressurising aperture may be provided at the closed end of the end-chamber for introducing the pressurising medium into the void between the near end of the pipeline pig and the closed end of the end-chamber.

In order to facilitate the recovery of a pipeline pig following its passage through a pipe and to maintain the pressure of the pressurising medium in the void between the remote end of the pipeline pig and the remote end of the pipe, the invention preferably provides a receiving chamber, preferably substantially cylindrical in internal shape, closed at one end and open at the other. The receiving chamber is substantially similar in cross-sectional area to the pipe through which the pipeline pig is to be passed and is of a length sufficient to accommodate the pipeline pig. The open end of the receiving chamber is formed so that it may be connected to the distal end of the pipe by a gas-tight or liquid-tight joint. A pressure control device such as a pressure relief valve may be provided which controls the pressure of the pressurising medium in the void between the remote end of the pipeline pig and the remote end of the pipe. The receiving chamber may be made of flexible material.

In the embodiment of the invention that relates to lining pipes, a flexible liner is positioned within a pipe to be lined as well as the protective tube. A pipeline pig is introduced into the protective inner tube at a near end of the tube. Means are provided for introducing the pressurising medium into the void in the liner between the near (rearward) end of the liner and the near end of the pipeline pig, which propels the pipeline pig through the protective inner tube towards the remote end of the pipe, spreading and pressing the liner radially outwards against the inner surface of the pipe being lined. The pressure of the pressurising medium is maintained at a level sufficient to keep the liner pressed against the inner surface of the pipe being lined following the passage of the pipeline pig. In order to ensure that the pipeline pig does not move through the liner at a rate sufficient to cause a reduction in the pressurising medium in the void in the liner between the near end of the liner and the near end of the pipeline pig there is desirably provided means of restraining the movement of the pipeline pig as follows, which may be used singly or in combination:
1. A rod or flexible line is provided which passes longitudinally through the pipeline pig and the motion of the pipeline pig through the liner is controlled by restraining the said rod or flexible line.
2. Means are provided for applying pressurised gas or liquid or a combination of gas and liquid in the void in the liner between the remote end of the liner and the remote end of the pipeline pig and the motion of the pipeline pig is controlled by controlling the relative pressures of the gas or liquid or combination of gas and liquid in the voids at either end of the pipeline pig.
3. A pipeline pig with enhanced inherent resistance to longitudinal rolling motion is used, necessitating the use of raised pressure in the gas or liquid or combination of gas and liquid in the void in the liner between the near end of the liner and the near end of the pipeline pig in order to propel the pipeline pig through the liner.

In an alternative arrangement, a rod or line is provided which passes longitudinally through a pipeline pig which has been constructed so as to exhibit enhanced resistance to longitudinal rolling motion. The pipeline pig is positioned within the protective inner tube. Means is provided for applying gas or liquid in the void in the liner between the rearward end of the pig at a pressure sufficient to keep the liner pressed against the inner surface of the pipe being lined following the passage of the pipeline pig but insufficient to propel the pipeline pig through the inner tube. Means are provided for pulling on or pushing on the rod or line, thereby propelling the pipeline pig through the inner tube. Thus a motive force is provided by the rod or line, and the gas or liquid acts only to maintain the liner in position subsequent to the passage of the pipeline pig.

A receiving chamber made of a flexible material may be provided, attached to a liner by a gas-tight or liquid-tight joint, which may be inserted into a pipe being lined together with the liner to which it is attached, thereby providing a method for inserting, spreading and pressing a liner against the inner surface of a pipe being lined, using access from one end only of the pipe being lined.

A connecting tube of a flexible material and of substantially similar diameter to the liner may be used to connect a liner and an end-cap or an end-chamber or a receiving chamber or any other form of pressure-tight seal for containing the pressure of the pressurising medium such as a gas or a liquid within the liner. Such a connecting tube is joined to the liner and to the end-cap or end-chamber or receiving chamber or other form of pressure-tight seal by gas-tight or liquid-tight joints.

Various embodiments will now be described, by way of example only, with reference to the accompanying drawings in which:

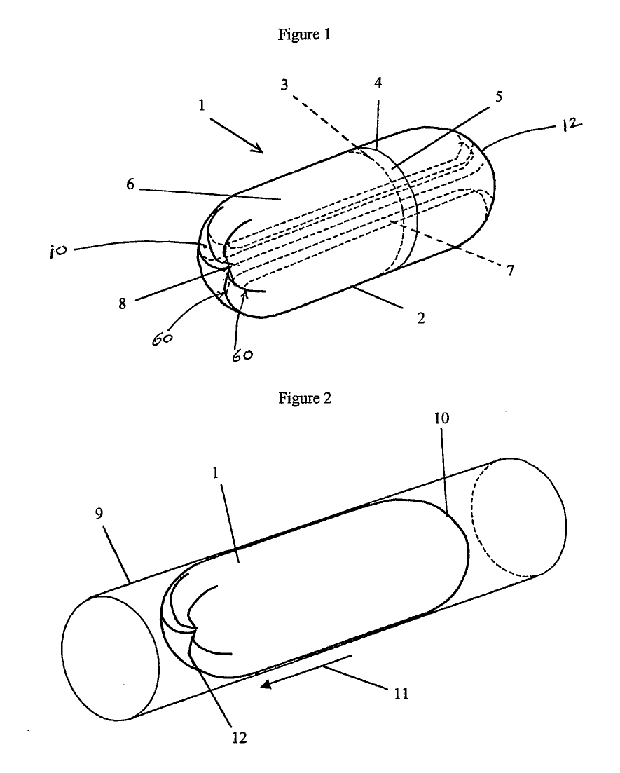

FIG. 1 is a perspective view of a pipeline pig;

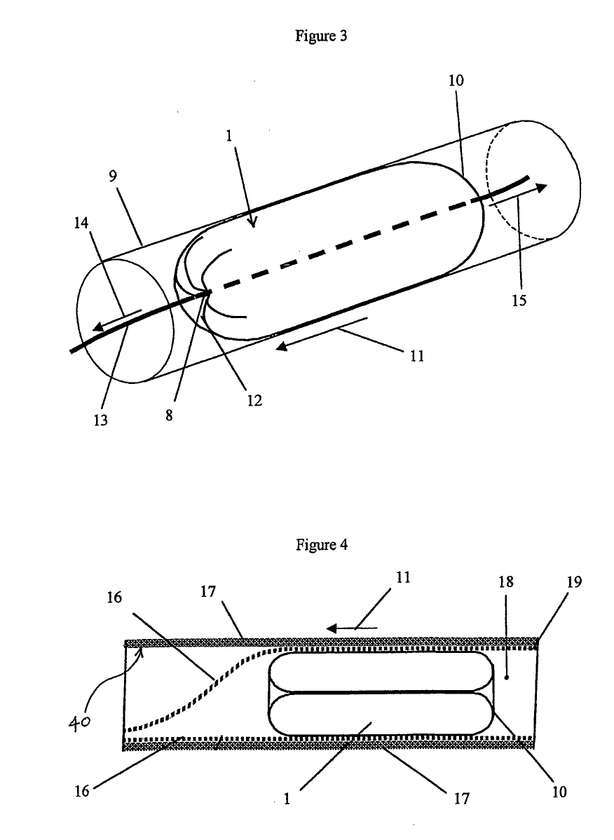

FIG. 2 is a perspective view of the a pipeline pig of FIG. 1 positioned in a pipe;

FIG. 3 is a perspective view of the pipeline pig of FIG. 1 positioned in a pipe, and a rod or line passing through the central passage of the pipeline pig;

FIG. 4 shows in longitudinal cross-sectional view a pipe being lined with the pipeline pig of FIG. 1;

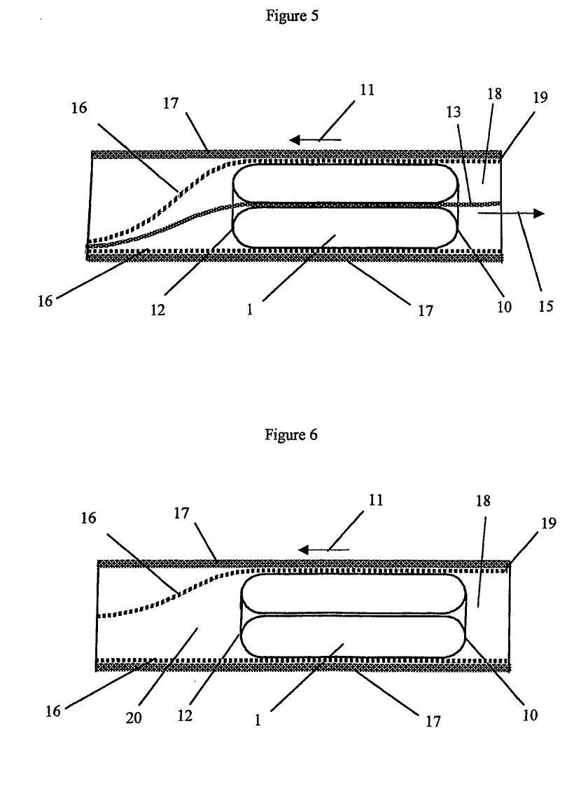

FIG. 5 is a longitudinal cross-sectional view of a pipe being lined, a liner within the pipe being lined, the pipeline pig of FIG. 1 and a rod or line passing longitudinally through the central passage of the pipeline pig;

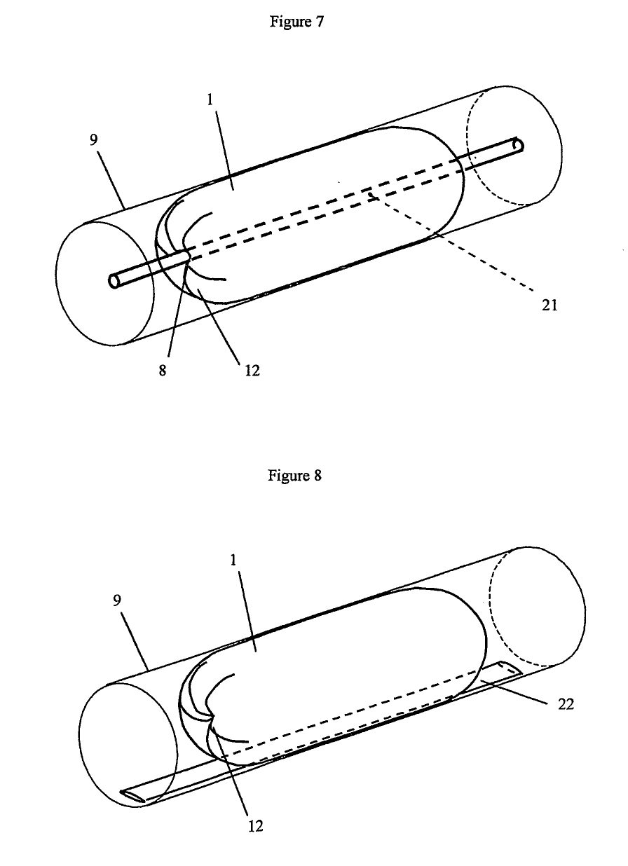

FIG. 6 shows in longitudinal cross-sectional view a pipe being lined, a liner within the pipe being lined and a pipeline pig within the liner and shows how the pipeline pig in conjunction with pressurising media may be used to spread, press and retain the liner against the inner surface of the pipe being lined.

FIG. 7 is a perspective view of the a pipeline pig of FIG. 1 positioned within a pipe and a pass-through tube positioned within the pipeline pig.

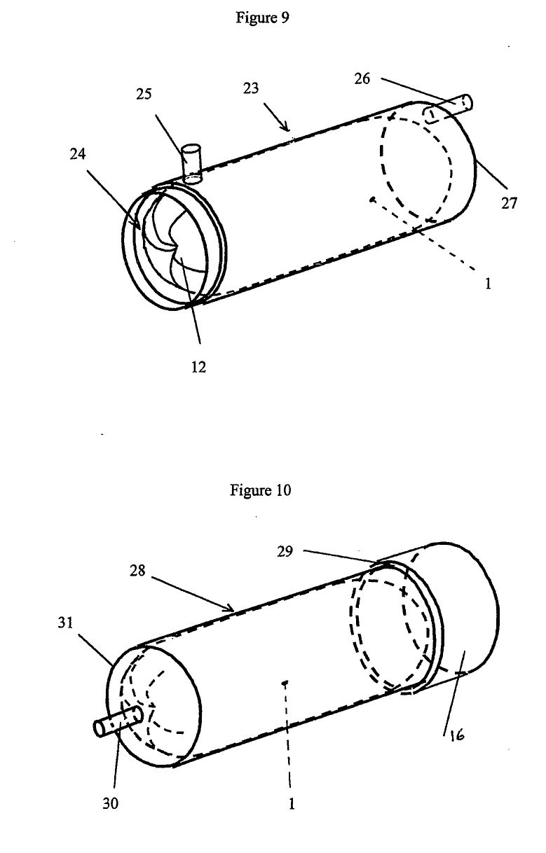

FIG. 8 is a perspective view of the pipeline pig of FIG. 1 positioned in a pipe and a bypass tube positioned between the inner surface of the pipe and the pipeline pig.

FIG. 9 is a perspective view of an end-chamber, the pipeline pig of FIG. 1 positioned in the end-chamber;

FIG. 10 is a perspective view of a receiving chamber attached to a pipe the pipeline pig of FIG. 1 positioned within the receiving chamber and a pressure control device attached to the receiving chamber;

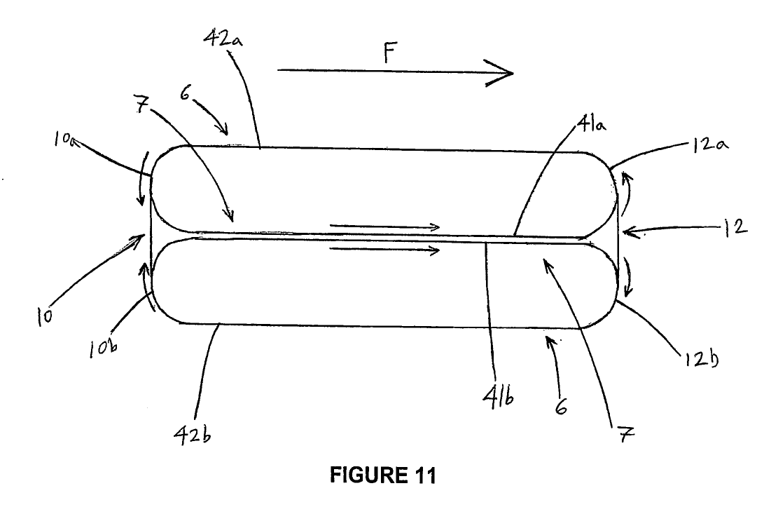

FIG. 11 is a schematic longitudinal cross-sectional view of the pipeline pig of FIG. 1;

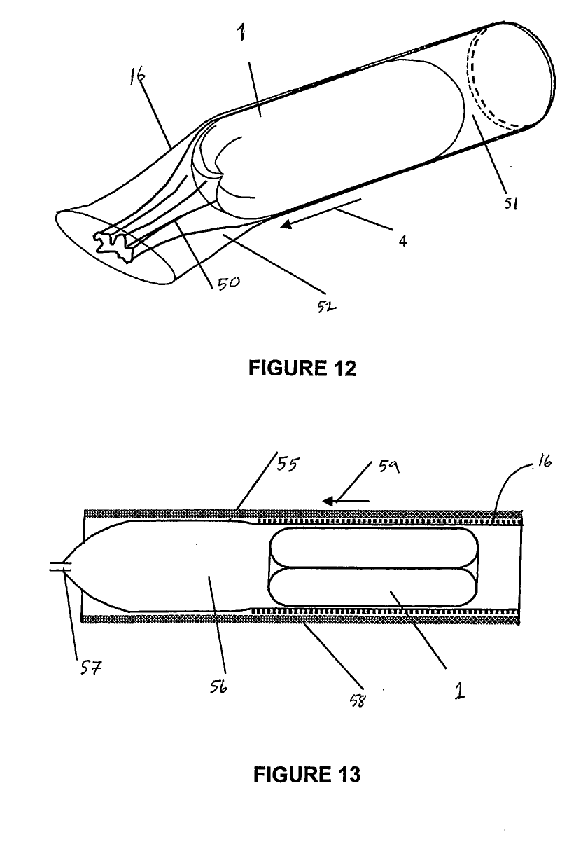

FIG. 12 is a perspective view of a portion of drain liner with a portion of inner tube being spread using a pipeline pig; and

FIG. 13 is a cross-sectional view of a portion of drain liner within a pipe being lined and the closed end of the inner tube,

With reference to FIG. 1 there is shown a pipeline pig 1 which comprises a flexible tubular membrane 2, everted at each end, where the first end 3 and the second end 4 have been brought together and joined around the circumference by a gas-tight joint 5 and the resulting enclosure 6 has been filled with gas under pressure (to approximately 1.5×10⁵ Pa) via an inflation valve (not shown). A radially inner wall 7 of the membrane that passes through the middle of the pipeline pig 1 forms a central passage 8. The radially inner wall 7 is compressed inwardly by the action of the gas so that the passage 8 is closed thereby. The pig 1 further comprises a radially outer wall 6 and distal ends 10 and 12. When viewed in transverse cross-section the inner wall 7 and the outer wall 6 form a substantially annular space.

It is to be noted that FIGS. 2 to 11 are intended to describe the general operation of the pipeline pig, as described above, and also set out various optional features of the inventive apparatus and method.

FIG. 2 shows the pipeline pig 1, which has been compressed and positioned within a pipe 9. The pig is sized so that it can be inflated to an external diameter which is greater than the internal diameter of the pipe 9. Pressure is thus exerted by the pipeline pig 1 radially towards the inner surface of the pipe 9. The pipeline pig 1 provides a substantially liquid-tight and gas-tight seal within the pipe 9. By introducing a pressurising gas under pressure (for example at 0.5×10⁵ Pa) into the pipe 9 at the near end 10 of the pipeline pig 1 by means not shown in FIG. 2, the pipeline pig 1 may be propelled through the pipe 9 in the direction 11 shown. If the pressurising gas is introduced under pressure into the pipe 9 at both the near end 10 and the remote end 12 of the pipeline pig 1, the pipeline pig 1 can be propelled through the pipe 9 in the said direction 11 by adjusting the pressures of the said pressurising media so that the pressure of the pressurising medium in the pipe 9 at the near end 10 of the pipeline pig 1 is greater than the pressure of the pressurising medium in the pipe 9 at the remote end 12 of the pipeline pig 1 by an amount sufficient to overcome any resistance to longitudinal rolling motion inherent in the pipeline pig 1.

As shown in FIG. 3, a rod or line 13 passes longitudinally through through the central passage 8 of the pipeline pig 1. There is frictional contact between the rod or line 13 and the inner wall 7 of the pipeline pig 1. By applying a force to the rod or line 13 in the direction 14 shown, the pipeline pig 1 may be propelled in the direction 11 shown. By restraining or pulling on the rod or line 13, the motion of the pipeline pig 1 may be restrained. Thus the motion of the pipeline pig 1 may be slowed, arrested or reversed by applying a force to the rod or line 10 in the direction 15 shown.

FIG. 4 shows a pipeline liner 16, positioned within a pipe 17 being lined and the pipeline pig 1 is positioned within the liner 16. A pressurising medium is introduced into a near-end void 18 in the liner 16, which is the void enclosed by the liner 16 between the near end 19 of the liner 16 and the near end 10 of the pipeline pig 1 and retained by means not shown in this FIG. 4 propelling the pipeline pig 1 in the direction 11 shown. As the pipeline pig 1 moves in the direction 11 shown, it spreads the liner 16 and presses the liner against inner surface 40 of the pipe 17. The pressure of the pressurising medium in the near-end void 18 that is required to propel the pipeline pig 1 in the direction 11 shown depends on the inherent resistance to longitudinal motion of the pipeline pig 1. If the pipeline pig 1 is constructed so as to be sufficiently inherently resistant to longitudinal motion, the pressure of the pressurising medium in the near-end void 18 may be maintained at a level that ensures that the portion of the liner 16 between near end 19 of the liner 16 and the near end 10 of the pipeline pig 1 continues to be pressed against the inner surface of the pipe being lined 17 following the passage of the pipeline pig 1 through the said portion of the liner.

FIG. 11 shows, schematically, how the pipeline pig 1 advances by the so-called ‘longitudinal rolling motion’. A net pressure is applied to the near end of the pig by a pressurising medium in the direction of the arrow F. The outer wall 6 bears against a liner (not illustrated in FIG. 11) and a frictional engagement between the outer wall 6 and the liner so that longitudinal slippage therebetween is prevented. This results in substantially radial portions of the walls of the pig following respective endless loops in which inner wall portions 41a and 41b move in substantially the same direction as the direction of movement of the pig. The position in the respective endless loops or material forming outer wall portions 42a and 42b move in a direction which is substantially opposite to the direction of movement of the pig, such movement being relative to the respective loop. Thus the remote ends 12a and 12b are ‘fed’ with replacement material from the inner wall portions 41a and 41b respectively, and the near end portions 10a and 10b are fed with material from outer wall portions 42a and 42b respectively. As can be best seen from FIG. 1 as material moves from end wall 10 towards inner wall 7, the material forms creases or folds 60. It will be appreciated that FIG. 11 is schematic, and in particular because the central passage 8 would not be open as shown but would, rather, be closed.

As shown in FIG. 5, liner 16 is positioned within the pipe 17 being lined, the pipeline pig 1 is positioned within the liner 16 and the rod or line 13 passes longitudinally through the middle of the pipeline pig 1. The pressurising medium is introduced under pressure into near-end void 18 in the liner 16. Means not shown in FIG. 5 are provided for applying a force to the rod or line 13 in the direction 15 shown. Pressure within the pressurising medium in the near-end void 18 propels the pipeline pig 1 in the direction 11 shown. As the pipeline pig 1 moves in the direction 11 shown, it spreads the liner 16 and presses said liner against the inner surface of the pipe being lined 17. The rate at which the pipeline pig 1 moves in the direction 11 shown may be controlled by applying a restraining force to the rod or line 13 in the direction 14 shown and thereby any reduction in the pressure of the pressurising medium in the near-end void 18 due to movement of the pipeline pig 1 may be controlled. The pressure of the pressurising medium in the near-end void 18 is maintained at a level that ensures that the portion of the liner 16 between the near end 19 of the liner 16 and the near end 10 of the pipeline pig 1 continues to be pressed against the inner surface of the pipe 17 subsequent to the passage of the pipeline pig 1 through the liner 16.

With reference to FIG. 6, the liner 16 is positioned within the pipe 17 and the pipeline pig 1 is positioned within the liner 16. The pressurising medium is introduced into remote-end void 20 in the liner 16, which is the void enclosed by the liner 16 between the remote end 12 of the pipeline pig 1 and the remote end (not shown) of the liner 16, which is the end of the liner 16 furthest from the near end 19 of the liner 16, and retained by means not shown in this FIG. 6. A pressurising medium is introduced under pressure into the near-end void 18 in the liner 16, which is the void enclosed by the liner 16 between the near end 19 of the liner 16 and the near end 10 of the pipeline pig 1, at a pressure that is greater than the pressure of the pressurising medium in the remote-end void 20 and retained by means not shown in this FIG. 6. The difference between the pressure of the pressurising medium in the near-end void 18 and the pressure of the pressurising medium in the remote-end void 20 is sufficient to propel the pipeline pig 1 in the direction 11 shown. Means not shown in FIG. 6 are provided for controlling the pressures of the pressurising media in the near-end void 18 and the remote-end void 20 which may include but are not limited to means for introducing additional gas or liquid under pressure into the near-end void 18 and the remote-end void 20 and means for the release of controlled quantities of the pressurising media from the near-end void 18 and the remote-end void 20. As the pipeline pig 1 moves in the direction 11 shown, it spreads the liner 16 and presses the liner 16 against the inner surface of the pipe 17. The pressure of the pressurising medium in the near-end void 18 is maintained at a level that ensures that the portion of the liner 16 between the near end of the liner 16 and the near end 10 of the pipeline pig 1 continues to be pressed against the inner surface of the pipe 17 following the passage of the pipeline pig 1 through the said segment of the liner 16.

As shown in FIG. 7, a pipeline pig 1 is compressed and positioned within the pipe 9. A pass-through tube 21 passes longitudinally through the central passage 8 of the pipeline pig 1. There may be frictional contact between the pass-through tube 21 and the pipeline pig 1 where they are in contact in the central passage 8 which may be reduced by lubrication or by wrapping the pass-through tube 21 in a lubricated tube or wrapper (not shown). A pressurising medium may be introduced into the pipe 9 at the remote end 12 of the pipeline pig 1 by passing the pressurising medium through the pass-through tube 21.

FIG. 8 shows the pipeline pig 1 compressed and positioned within a pipe 9. A bypass tube 22 passes longitudinally between the inner surface of the pipe 9 and the pipeline pig 1. The pressurising medium is introduced into the pipe 9 at the remote end 12 of the pipeline pig 1 by passing it through the bypass tube 22.

FIGS. 7 and 8 thus show how a second pressurising medium could be applied to the remote side of the pipeline where access to a remote end of the pipe is restricted.

FIG. 9 shows an end-chamber 23 within which the pipeline pig 1 is positioned. The open end 24 of the end chamber 23 is formed so that it may be attached to a pipe (not shown) (or a liner, or a protective inner tube) by a gas-tight or liquid-tight joint. A first pressurising aperture 25 is located near to the open end 24 of the end-chamber 23, between the remote end 12 of the pipeline pig 1 and the open end 24 of the end-chamber 23. A second pressurising aperture 26 is located at the closed end 27 of the end-chamber 23. There is provision for introducing a pressurising medium into the end chamber 23 through both the first pressurising aperture 25 and the second pressurising aperture 26.

FIG. 10 shows a receiving chamber 28 attached to the liner 16 by a gas-tight or liquid-tight joint 29. The pipeline pig 1 is positioned within the receiving chamber 28. A pressure control device such as a pressure relief valve 30 is located at a closed end 31 of the receiving chamber 28, by means of which the pressure of the pressurising medium in the pipework to which the chamber is connected is controlled as the pipeline pig 1 progresses through the pipework.

A highly preferred embodiment of the invention comprises an inner protective tube comprising a flexible tubular membrane that is inserted into the drain liner prior to the insertion of the drain liner into the pipe being lined. The circumference of the inner protective tube is similar to the inner circumference of the drain liner so that it may be spread out so that it is contiguous with the inner surface of the drain liner. The inner protective tube may be longer than the drain liner so that, following insertion into the liner, it protrudes beyond one or both ends of the drain liner.

As is shown in FIG. 12, an inner protective tube 50 is positioned within the liner 16. The pipeline pig 1 is passed through the inner protective tube 50 in the direction 4 by the action of the pressurising medium. Portion 51 of the inner protective tube 50 through which the pipeline pig 1 is passing or has passed is spread so that it is contiguous with the inner surface of the drain liner. Portion 51 of the inner protective tube 50 through which the pipeline pig 1 has not yet passed remains in an unordered state formed when inserted into the drain liner 16.

FIG. 13 shows in longitudinal cross-section the end of an inner protective tube 55 within a drain liner 16 which is positioned within a pipe 58. A pipeline pig 1 is positioned within the inner protective tube 55 and is moved in the direction 59 shown by the action of the pressurising medium. The end of the inner protective tube 55 is closed, forming an end-chamber 56 into which the pipeline pig may pass and be held. An aperture outlet 57 serves to release air or whichever pressurising medium is used that may be in the end-chamber 56. The outlet 57 may be fitted with a pressure control valve.

The inner protective tube 50 serves primarily to protect the pipeline pig 1 from contamination by material such as resin impregnate and also may serve as a conduit for the pipeline pig if it is desired to install a drain liner in a position such that one or both ends of the drain liner is located within the pipe being lined at a distance from the point or points of access to the pipe being lined. The inner protective tube may be made of a material that is resistant to adhesion to or contamination by the materials used in the lining process such as the resin used for impregnation.

Following the installation of a drain liner, the inner protective tube may be removed, typically by cutting it out or peeling it away from the inner surface of the drain liner.

The pipeline pig 1 also finds utility in clearing pipelines, for example of unwanted gases and/or liquids. In such an application the pipeline pig would form a substantially liquid and/or gas tight seal with an inner surface of the pipeline.

The pipeline pig described above has many important advantages. One advantage is that the pipeline pig is generally much quicker and simpler to use than known methods/apparatus. Also the pipeline pig is a relatively low cost device and so it is possible to manufacture pigs of different dimensions for differently dimensioned pipes.

It will be appreciated that there are various ways of manufacturing the pipeline pig. For example mould halves (longitudinal or transverse) could be bonded together. Alternatively, the pipeline pig may be manufactured from a sheet of flexible material.

It is envisaged that the pipeline pig of the present invention would typically be suitable for use with pipes of between 8 cm to 24 cm in diameter, however for some applications, and in particular for cleaning pipes in the gas and oil industries, the pipeline pig could be suitable for use with pipes of approximately 60 cm or greater.

1-27. (canceled)

28. Pipeline lining apparatus comprising a pipeline pig and an inner tube (50), the pipeline pig comprising longitudinal inner (7) and outer (6) walls and end walls (10,12), said inner and outer walls being of substantially annular arrangement in transverse section, the pig being such that, in use, space enclosed by said walls is filled with fluid, and on applying a motive force to the pipeline pig, the pipeline pig advances along a pipeline by way of substantially radial portions of the walls following respective endless loops (10a, 12a, 41a, 42a), the apparatus being such that, in use the pipeline liner and the inner tube are located within a pipeline, the inner tube being spread out against an inner surface of the pipeline liner prior to insertion into the pipeline, and the pipeline pig is caused to pass through the pipeline liner and the inner tube so as to urge said pipeline liner and said inner tube radially outwards towards an inner surface of the pipeline.

29. Apparatus as claimed in claim 28, in which the pipeline is filled with gaseous matter.

30. Apparatus as claimed in claim 28, in which the pipeline is filled with liquid.

31. Apparatus as claimed in claim 28, in which the pipeline pig is filled with fluid to a pressure in the range 0.3×10⁵ Pa to 10×10⁵ Pa.

32. Apparatus as claimed in claim 31, in which the pipeline pig is filled with fluid to a pressure of approximately 1.5×10⁵ Pa.

33. Apparatus as claimed in claims 28, 29, 30, 31, or 32, in which the pipeline pig is provided with a valved inlet which enables the pig to be filled with fluid.

34. Apparatus as claimed in claim 28, in which the pipeline pig is formed from a flexible tubular membrane which is everted at each distal end, and the distal ends attached to each other.

35. Apparatus as claimed in claim 34, in which the pipeline pig is formed from a flexible elastic membrane.

36. A method of installing a pipeline liner in a pipeline comprising positioning the pipeline liner in the pipeline, positioning a pipeline pig towards one end of the pipeline liner and applying a motive force to the pipeline pig so as to cause the pipeline pig to advance through the pipeline liner, the pipeline pig comprising longitudinal inner (7) and outer (6) walls, and end walls (10,12), said inner and outer walls being of substantially annular arrangement in transverse section, the pipeline pig being such that, in use, space enclosed by said walls is filled with fluid, and the pipeline pig advances along the pipeline by way of substantially radial portions of the walls following respective endless loops (10a, 12a, 41a, 42a), the method further comprising positioning a pipeline liner (52) and an inner tuber (50) in the pipeline (17), the inner tube being spread out against an inner surface of the pipeline liner prior to insertion into the pipeline, and causing the pipeline pig to pass through the pipeline liner and the inner tube so as to urge said pipeline liner and said inner tube radially outwards towards an inner surface of the pipeline.

37. A method as claimed in claim 36 which comprises filling the pipeline pig with fluid until the pipeline pig is capable of exerting a required radially outward pressure towards an inner surface (40) of the pipeline (17) when the pipeline pig is inside the pipeline.

38. A method as claimed in claim 36 which comprises applying a pressurising fluid to a rearward end of the pipeline pig (1) so as to cause the pipeline pig to advance through the pipeline (17).

39. A method as claimed in claim 36 which comprises filling the pipeline pig with fluid until sufficiently filled so that when the pipeline pig is inside the pipe a seal is formed between a downstream space (20) adjacent to a forward end (12) of the pipeline pig and an upstream space (18) adjacent a rearward end (10) of the pipeline pig.

40. A method as claimed in claim 39, in which the seal is sufficient to prevent pressurising fluid in the downstream space (20) from passing to the upstream space (18).

41. A method as claimed in claim 36 which comprises locating a launch chamber (23) towards one end of the liner (16), the launch chamber comprising an inlet (26) for receiving the pressurising fluid.

42. A method as claimed in claim 36 which comprises locating a receiving chamber (28) towards an opposite end of the pipeline liner (16).

43. A method as claimed in claim 42, in which the receiving chamber (28) comprises a pressure relief outlet (30).

44. A method as claimed in claim 36 which comprises passing an elongate member (13) through a central passage (8) of the pipeline pig (1) which passage is defined by the inner wall (7), the elongate member being in frictional engagement with the inner wall.

45. A method as claimed in claim 44 which comprises moving the elongate member in the central passage (8) so as to control movement of the pipeline pig as the pipeline pig advances through the pipeline (17).

46. A method as claimed in claim 36 which comprises feeding a conduit (21) through a central passage (8) of the pipeline pig (1) which passage is defined by the inner wall (7) of the pipeline pig, and supplying pressurising fluid through the conduit to a space adjacent a forward end (12) of the pipeline pig.

47. A method as claimed in claim 36 which comprises locating a conduit (22) between the outer wall (6) of the pipeline pig and an inner surface of the pipeline, and supplying pressurising fluid through the conduit to a space adjacent a forward end (12) of the pipeline pig.

48. A method as claimed in claim 36, in which a downstream end (55) of the inner tube (50) is adapted to receive and capture the pipeline pig.

49. A method as claimed in claim 48, in which the downstream end (55) is provided with a pressure relief outlet (57).

50. A method as claimed in claim 36 which comprises maintaining pressurising fluid in the pipeline for a predetermined time after the pipeline pig has passed through said pipeline.

51. A method as claimed in claim 36, in which pressurising fluid provides a pressure in the pipeline of between 0.2×10⁵ to 2×10⁵ Pa.

52. A method as claimed in claim 36, in which pressurising fluid provides a pressure in the pipeline of approximately 0.5×10⁵ Pa.
